(19) United States
(12) Patent Application Publication
(10) Pub. No.: US 2025/0227516 A1
(43) Pub. Date: Jul. 10, 2025

(54) TELECOMMUNICATIONS NETWORK PERFORMANCE SIGNATURES

(71) Applicant: MICROSOFT TECHNOLOGY LICENSING, LLC, Redmond, WA (US)

(72) Inventors: William Lee LABOR, JR., Dagsboro, DE (US); Alejandro Jose MIGUEL, Sammamish, WA (US); Anthony Justin HOWE, Seattle, WA (US); Noah KIPLING WEIS, New York, NY (US)

(21) Appl. No.: 18/409,657

(22) Filed: Jan. 10, 2024

(51) Int. Cl. H04W 24/04; H04W 24/10

(52) U.S. Cl. CPC H04W 24/04; H04W 24/10

(57) ABSTRACT

Telecommunications network monitoring is described. Behaviour signatures are generated, each associated with a different network problem. Each signature is assigned a plurality of performance metrics that indicate that network problem. The performance metrics are sourced from two different models. Receiving network data from a telecommunications network and generating the performance metrics from that data. Then ranking the signatures according to a prioritization scheme. Then presenting the highest-priority signature to an operator and receiving feedback which is used to update the prioritization scheme.

### BACKGROUND

Managing a modern telecommunications network, such as a private 5G network, is a serious technical challenge, at least because of the complexity and strict requirements on performance. Data about the performance and status of network devices is collected constantly from multiple devices on the network. Experienced operators can search through this data for anomalies to monitor performance and diagnose problems in the network. These network problems are created by both software and hardware issues and give rise to many different symptoms. Network monitoring applications provide long lists of network data to operators on dashboard user interfaces.

The embodiments described below are not limited to implementations which solve any or all the disadvantages of known telecommunications network management systems.

### SUMMARY

The following presents a simplified summary of the disclosure to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples, a plurality of signatures is generated with each signature being associated with a different network problem. Each signature is assigned with a plurality of metrics that together indicate the associated network problem. In each signature the metrics are generated by two or more different types of models. Network data is received about a telecommunications network. The plurality of performance metrics is generated using the received data. The signatures are ranked according to a prioritization scheme to obtain a highest-priority signature. The highest-priority signature is presented to an operator. Feedback is received from the operator about the highest-priority signature and the prioritization scheme is updated using the feedback.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read considering the accompanying drawings, wherein:

FIG. 1 is a schematic diagram of a telecommunications network architecture for performance monitoring.

FIG. 2 is a schematic diagram of generating performance metrics.

FIG. 3 is a schematic diagram of signature prioritization.

FIG. 4 is an example dashboard for a highest-priority signature.

FIG. 5 is a flow diagram of a network monitoring method.

FIG. 6 is a flow diagram for generalizing performance metrics.

FIG. 7 illustrates an exemplary computing-based device in which embodiments of FIGS. 1-6 are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

As mentioned above, managing a modern telecommunications network, such as a private 5G network, is a serious technical challenge, at least because of the complexity and strict requirements on performance. Data about the performance and status of network devices is collected constantly from multiple devices on the network. Experienced operators can search through this data for anomalies to monitor performance and diagnose problems in the network. These network problems are created by both software and hardware issues and give rise to many different symptoms. Network monitoring applications provide long lists of network data (also referred to as telemetry data or network performance data) to operators on dashboard user interfaces. The resulting dashboard user interface display is often overwhelming and it becomes difficult for a telco operator to quickly and accurately assess rapidly changing conditions in the telecoms network.

To provide context to network data it is categorized into performance metrics. This goes some way to help correlate the data with known patterns for different network problems. The current trend is to generate more and more metrics from a network and provide them to an operator in a monitoring dashboard. However, increasingly providing more metrics does not provide greater insight into a specific network problem. Instead, frequently it causes operators to have to navigate a ‘sea of charts’, many of which are irrelevant to the problem at hand.

The inventors have recognized that it is possible to reduce the number of performance metrics transmitted to an operator while still allowing effective monitoring. This has been done by creating signatures for different network problems, assigning the signatures with relevant performance metrics, generating the performance metrics for a specific network and ranking the signatures for presentation to an operator. A signature of a network problem is a collection of relevant performance metrics that indicate that the network problem is present in the network; that is, a signature of a network problem comprises a plurality of specified performance metrics. By ranking the signatures and presenting only a top most ranked signature, or only a top k of the ranked signatures, where k is an integer below 10, is found to significantly improve usability of a telco operator dashboard. However, it is difficult to determine how to rank the signatures. Inappropriate ranking can lead to detrimental management of the telecommunications network. Because of continual changes in the communications network, a ranking scheme which is efficient today may become inefficient tomorrow.

In some examples, the present technology learns how to rank the signatures using reinforcement learning. Telco operators or automated systems take action triggered by the ranked signatures. The action (or lack of action) is observed and recorded as feedback. Such feedback about the utility and outcomes after presenting the signatures is used to update the signature ranking scheme using reinforcement learning, further improving network monitoring. In some examples, the reinforcement learning operates on the fly as the telecommunications network is in use which gives the benefit that changes in the telecommunications network which occur over time, due to equipment upgrades, changes in customer demand, maintenance, equipment failure and other factors can be taken into account.

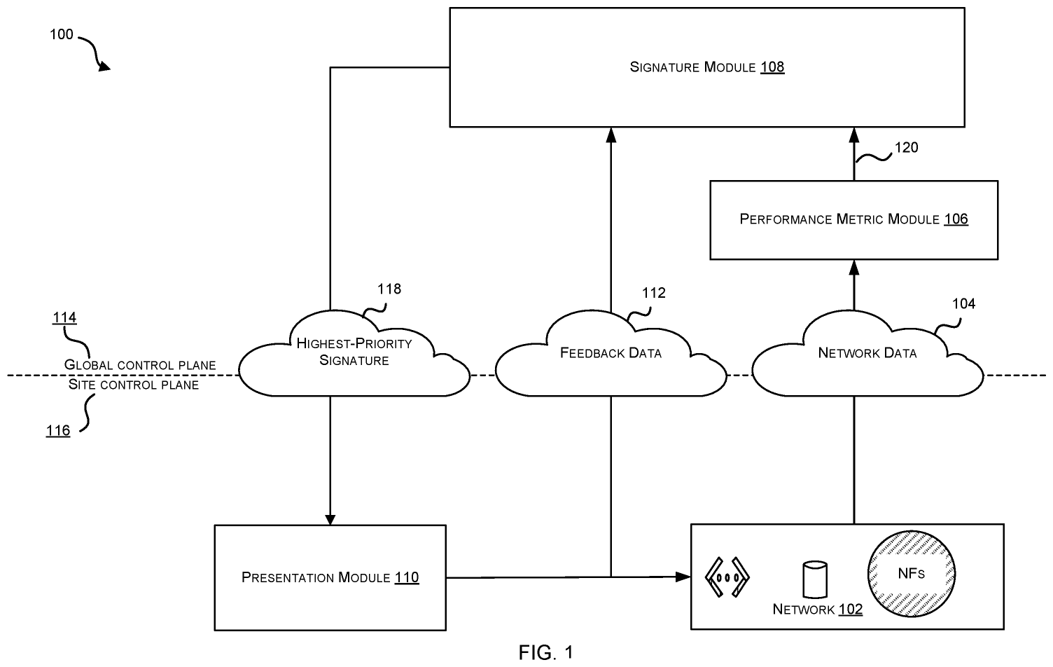

FIG. 1 is a schematic diagram of a network monitoring system 100. The example system 100 is split into a site control plane 116 and a global control plane 114. The site control plane 116 comprises the network to be monitored 102 and a presentation module 110. The global control plane 114 comprises a performance metric module 106 and a signature module 108, where a highest-priority signature 118 is generated by functionality in the global control plane 114 and sent for display and actioning in the local site control plane 116. Network data 104 recorded from the network 102, a highest-priority signature 118, and feedback data 112 collected by the signature presentation module 110 passes from the site control plane 116 to the global control plane 114.

An operator desiring to monitor the network 102 for performance problems begins with the collection of network data 104. The network data 104 is collected from devices on the network capable of collecting performance measurements and forwarding them to the site control plane 116, such as routers, switches, firewalls, gateways, servers, edge devices, 5G nodes, and virtual network functions. The network data 104 is received at the global control plane 114 for analysis. The network data 104 includes quantitative data such as bits per second (bps), jitter, packet loss rate, and round-trip-time (RTT) along with qualitative data such as customer experience ratings, alerts and system logs. In one example, types of quantitative data in the network data 104 are selected according to predefined types required in a traffic model. The traffic model takes into account a size and expected utilization of the network 102, the quantitative data for the model is then complemented by the system logs and the alerts from the network 102. The network data 104 is transmitted to the performance metric module 106 in the global control plane 114 through wired or wireless connections.

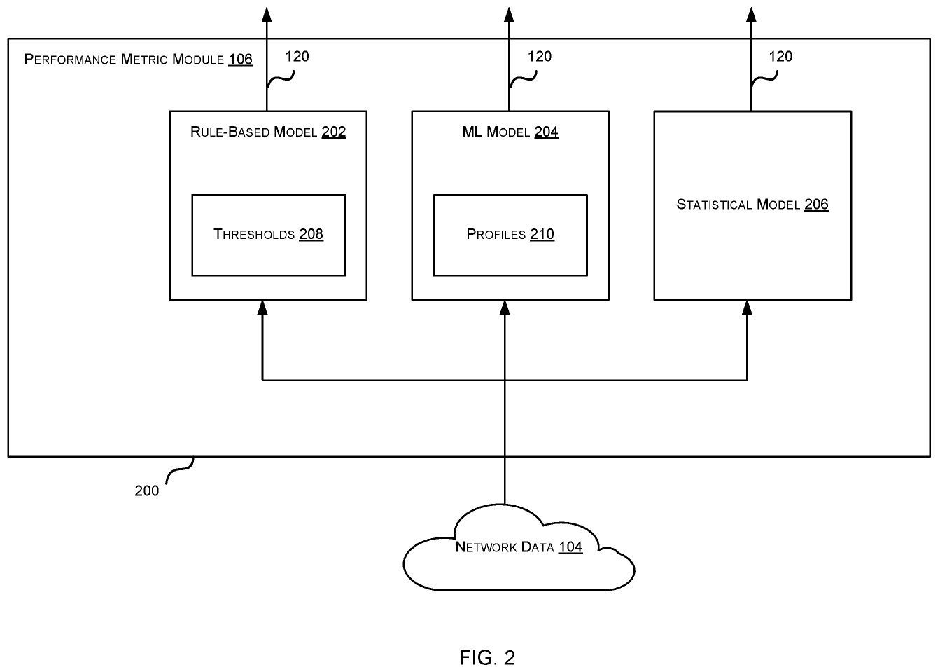

The performance metric module 106 receives the network data 104 and generates a plurality of performance metrics 120. The performance metrics 120 are generated by applying at least two different types of models to the network data 104. While network data 104 includes all measurements from the devices of network 102, performance metrics 120 are generated when there is an anomaly in the network data 104 from the expected value for the network data 104. Therefore, performance metrics 120 are more likely to indicate an issue with the network. The operation of the metric generation module 106, which computes the performance metrics, is explained in more detail below regarding FIG. 2.

In system 100, a plurality of signatures are generated and stored by the signature module 108. The signatures are generated before monitoring takes place and can be updated at runtime. The latest generated values for the assigned performance metrics 120 are applied to the signatures in each period of a plurality of time periods. Each signature is associated with a different network problem. In some examples, the operator of the system 100 designs the signatures by selecting or defining a network problem and selecting the performance metrics 120 for that signature. Non-exhaustive examples of network problems include application crashes, Distributed Denial of Service (DDOS) attacks, network congestion, and hardware failure.

Each signature comprises two or more performance metrics 120 generated by two or more different types of model. Each model describes or represents behaviour of the communications network. The performance metrics 120 assigned to each signature are predefined to indicate the network problem. This can be based on historical patterns of performance metrics 120 during previous network problems. In examples where the type of network data 104 is selected according to a network model, the performance metrics 120 in each signature are selected based on historic positive or negative correlations between values of the performance metrics 120 and key performance indicators in the network model. Optionally, each signature includes instructions to perform an action on the network 102 to alleviate the associated network problem.

A signature provides a more accurate indication of a network problem than any one performance metric because it includes two or more metrics that are each a symptom of the problem (where a problem is also referred to as an anomaly). Additionally, having performance metrics 120 from two or more models included in each signature improves the accuracy because it increases the breadth of anomalies that can be detected. Optionally, a signature always includes a performance metric from a machine learning model and at least one other model source. This is advantageous for finding unexpected network problems because the machine learning model can explore for novel anomalies outside of pre-set statistical or rule-based thresholds.

Having received the generated performance metrics 120 from the performance metric module 106 and stored them with their assigned signatures, the signature module 108 applies a prioritization scheme to the plurality of signatures. The prioritization scheme determines a ranking of the plurality of signatures. One example prioritization scheme is a logic ranking system which considers the number of performance metrics 120 present in the signature and a combined severity score of the performance metrics 120. A high number of fulfilled performance metrics 120 for the signature is a strong indication that the associated network problem is present. Additionally, a high combined severity score (where a combined severity score is an aggregate of the performance metrics) is a strong indication that the performance metrics 120 generated have a large impact on network performance. In other examples the prioritization scheme is a reinforcement learning model that selects a highest-priority signature 118 from the plurality of signatures based on policy and reward functions applied to the latest assigned performance metrics 120. In either case, the output of the signature module 108 is a highest-priority signature 118 to be presented to the operator.

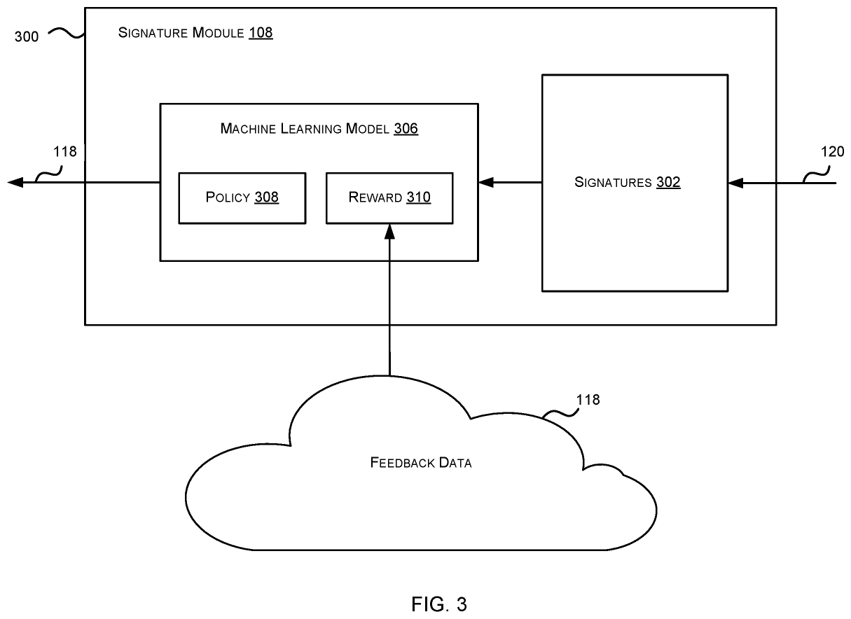

The prioritization scheme is updated based on operator feedback regarding the highest-priority signature 118. For example, if an operator feeds back positive feedback such as that a highest-priority signature 118 is applicable to the network problem or includes useful performance metrics 120, then the prioritization scheme will be updated to increase the likelihood that in similar network conditions the same signature will be highly ranked again. The prioritization of signatures is explained in more detail below regarding FIG. 3.

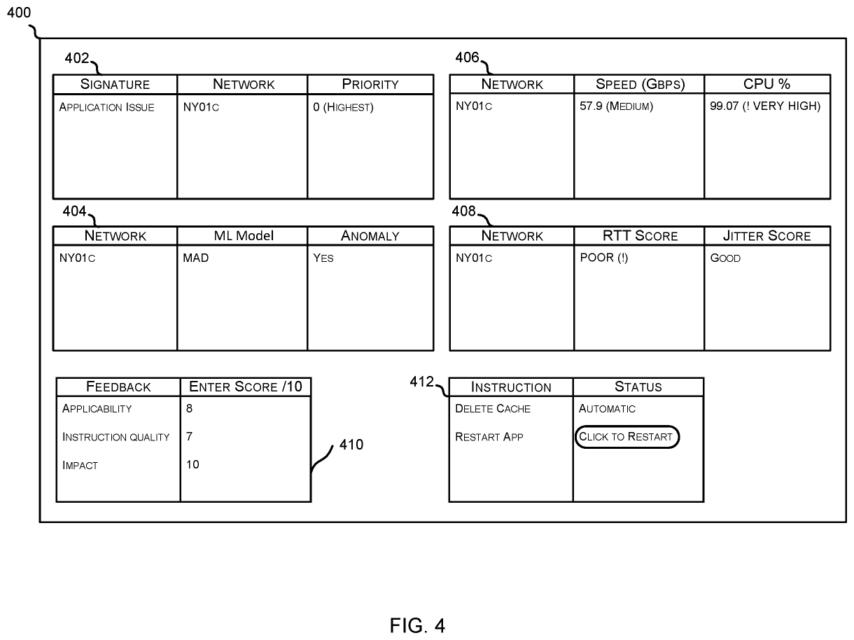

The highest-priority signature 118 is forwarded to the presentation module 110 using a wired or wireless connection. In example system 100, the presentation module 110 is in the site control plane 116. The received highest-priority signature 118 includes the performance metrics 120 assigned to the signature and optionally, a label for the associated network problem, and optionally a set of instructions to perform an action on the network 102 to alleviate the associated network problem. The presentation module 110 presents this to the operator via presenting means such as a display monitor. In one example the highest-priority signature 118 is presented to the operator by generating a dashboard interface. The dashboard is displayed to the operator and comprises portions displaying the signature and additional portions for the assigned performance metrics 120. Additionally, a feedback portion enables an operator to provide inputs to communicate the feedback to the signature module for adjusting the prioritization scheme for future network data 104. An example dashboard interface is explained in more detail below regarding FIG. 4.

The presentation module is optionally able to trigger actions on the network in response to the feedback. In one example, if there is positive feedback the presentation module 110 automatically triggers an action on the network 102 based on the highest-priority signature 118. In one example, the action is determined by the instruction steps in the highest-priority signature 118. When instructions are present the presentation module 110 processes the instruction steps and performs the action on the network 102 or sends the instructions to a node in the communications network for execution. In another example, the highest-priority signature 118 does not contain instructions and instead a retrieval augmented generation (RAG) approach is used to send prompt context to a language model with a transformer architecture, to generate the instructions. A non-exhaustive list of example language models is GPT-3, GPT-4, BLOOM, Llama, Bard, Gemini. The prompt context comprises past communications network data and current communications network data. Information retrieval on a ticket log is carried out to retrieve around ten of the closest example tickets. The ticket log is a record of customer troubleshooting requests regarding the telecommunications network.

FIG. 1 illustrates the functionality implemented by modules distributed over two control planes. The global control plane 114 is global meaning it controls several site control planes 116. Alternatively, the processing of the modules in system 100 is carried out entirely in the site control plane 116 or entirely in the global control plane 114. Alternatively, or in addition, the functionality of the performance metric module 106, signature module 108 and presentation module 110 described herein is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

FIG. 2 illustrates an example architecture of a performance metric module 106. In this example, there are three models used to generate the performance metrics 120 from the network data 104. A rule-based model 202, applies pre-defined thresholds 208 to the network data 104, this results in a plurality of performance metrics 120 indicating where the network data exceeds one of the thresholds 208 (and is therefore anomalous).

The rule-based model 202 is also capable of applying rules to qualitative network data such as syslog messages or alarms and converting them into an appropriate performance metric. For example, a rule that receiving a system log message alerting that a key performance indicator has been underperforming for a certain period automatically results in a ‘poor’ performance metric.

Machine Learning (ML) model 204 receives the network data 104 and produces a plurality of performance metrics 120. In the example of FIG. 3, the ML model is an unsupervised multivariate anomaly detection model. This model creates a historical profile 210 for each of a plurality of different types of network data 104. When the new network data 104 is received the ML model 204 outputs performance metrics 120 based on comparison to the historical profiles 210. Before building the profiles 210 from historical data, the model may be seeded with thresholds 208 applied in the rules-based model 202 as a starting point. In other examples, a different ML model is used such as a supervised learning model.

Statistical model 206 applies statistical techniques to the network data 104 such as determining the statistical significance, correlation, and seasonality of pieces of network data 104. In an example, each model receives the same network data and in other examples the ML model 204 receives all the network data and the statistical model 206 and rule-based model 202 each receive a portion of the network data that is most applicable for that model.

FIG. 3 illustrates an example architecture 300 for a signature module 110. In the example architecture 300, the signature prioritization module 110 comprises the stored signatures 302 and a prioritization scheme in the form of a machine learning model 306. The inputs to the signature prioritization module 110 are the performance metrics 120 and the feedback data 112. The output is a highest-priority signature 118 from the stored signatures 302. The signatures 302 are each associated with a different network problem. The signatures 302 are assigned two or more performance metrics 120 that each indicate the network problem exists in the network 102. The received performance metrics 120 are stored with their assigned signatures 302, each performance metric can be assigned to multiple signatures if the multiple signatures have been predefined to include the same metric. In one example, the signatures are defined by the operator selecting a network problem and a plurality of performance metrics 120.

In the example of FIG. 3, the signatures 302, including their assigned performance metrics 120 are input to the machine learning model 306. The machine learning model 306 selects a signature as a highest-priority signature 118. In an example, the machine learning model 306 is a reinforcement learning model which performs the ranking by selecting a highest-priority signature 118 according to a policy function 308 and reward function 310. A number of environment states being the number of the signatures 302 and a action being to order the signatures in a specific way 302 including selecting one as highest ranking by priority. The reward function is updated by the feedback received from the operator in the presentation module. Where positive feedback is received the reward function is updated to improve the chance that the same signature will be output for a similar environment state in future periods.

In an example the signature is formed by latency, jitter, throughput, and packet loss. Define a reward signal that is proportional to the performance of the network with respect to the signature. The system then uses a reinforcement learning algorithm (e.g. DQN) to learn to maximize the reward signal by selecting the actions that prioritize the signature. The reward signal function depends on the difference between the desired value (input from the human) and the measured priority value. The reward signal encourages the system to display the signatures in that priority order (higher or lower in the ranked list). The proportional signal can also have several components. For example the Reward R can be equal to R1+R2+R3, etc. Where R1, R2, R3 are proportional rewards for different variables, such as reliability, performance, resilience.

FIG. 4 illustrates an example dashboard 400 used to present the highest-priority signature 118. A first portion 402 of the dashboard 400 presents the signature label “Application Issue”, the network name “NYC01c” and a priority of “0”. Priority 0 in this example is the highest priority level. This provides the operator with context for the overall signature before they examine the details of the performance metrics 120 included. Optionally, an instruction portion 412 is included in the dashboard which contains instruction steps based on the highest-priority signature. In this example the instruction portion includes two instructions “Delete cache” and “Restart app”. The first is an automatically applied action as shown by the automatic status in the instruction portion 412. Additionally, the instruction portion 412 includes instruction with controls for a user to input a command, for example the restart app control in the instruction portion 412.

Portions 404-408 present the performance metrics 120 included in the “Application Issue” signature. In a second portion 404, a performance metric generated by an ML model is presented. In the example of dashboard 400, the ML model is a multivariate anomaly detection model. The anomaly column informs the operator that the machine learning model has discovered an anomalous event in the network data.

The third portion 406 presents performance metrics 120 generated by the statistical model. The first is the network speed in Gbps and the second is the CPU utilization. Applying a statistical technique, such as correlation, to the performance data in these two areas has detected anomalous values of very high CPU use and medium network speed metrics.

The fourth portion 408 presents the performance metrics 120 generated by the rule-based model. Two performance metrics 120 are presented, the RTT score and Jitter Score. By applying predefined thresholds to network data on RTT and jitter rate the rule-based model has determined that the RTT score exceeds the threshold for acceptable performance and has been highlighted and listed as POOR.

Finally, portion of the dashboard 400. The operator is presented with a list of three feedback controls with which to grade the highest-priority signature. Entering a score provides the feedback values to adjust the prioritization scheme. In this example, the operator grades the applicability, instruction quality of the highest-rank signature and the impact of the network problem it is associated with. Optionally, autonomous data is collected based on the operator's actions after viewing the dashboard, for example using the restart control is interpreted as the signature being applicable and having a high instruction quality.

In examples, other information about the performance metrics is presented in the dashboard 400 such as timestamps, frequency, location etc. Presenting the dashboard 400 including the signature and the generated performance metrics 120 related to the network problem improves the efficiency of managing a complex network by reducing the searching required by an operator. Additional redundant network data 104 and performance metrics 120 for this problem are not transmitted without further queries from the operator which saves communication bandwidth and hardware resources.

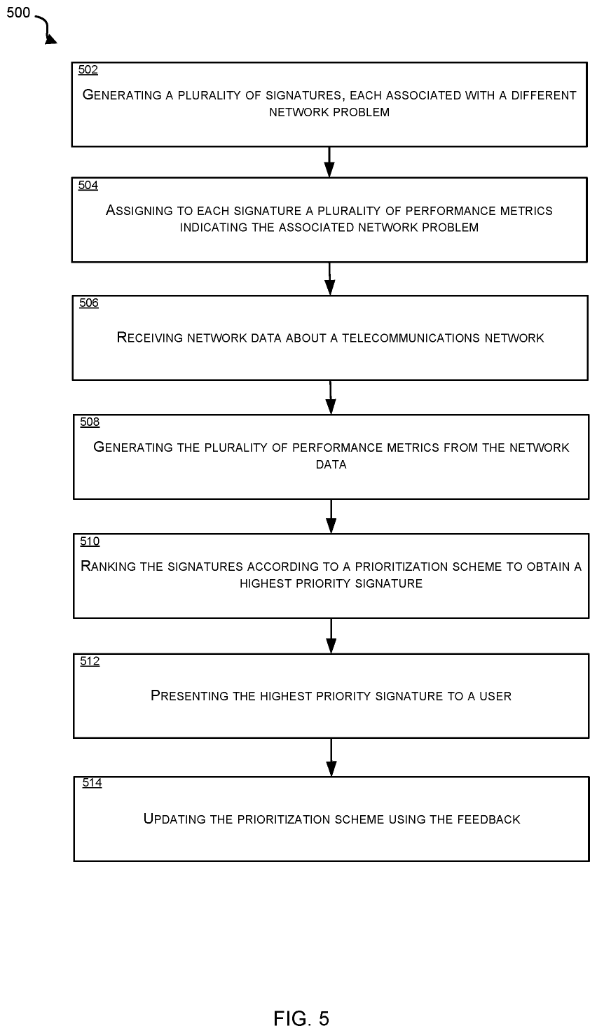

FIG. 5 illustrates a computer-implemented method 500. Starting in method block 502 with generating a plurality of signatures, each signature being associated with a different network problem. In one example, the signature further comprises instructions to perform an action on the network to alleviate the associated network problem. In another example, the network problem is in a 5G telecommunications network.

Method block 504 continues the method 500 with assigning to each signature a plurality of performance metrics 120 that indicate the network problem associated with the respective signature, wherein, for each signature the performance metrics 120 are generated by two or more different types of models. In one example, the operator selects the network problem to associate with the signature and the two or more-performance metrics 120 from two or more different types of models. The two or more different types of models comprise models capable of generating performance metrics 120 from network data, such as a rule-based model, a statistical model, and a machine learning model. The rule-based models generate performance metrics 120 by applying thresholds to one ore more respective portions of the network data. The network data is outputted as a performance metric when the thresholds are exceeded for the specified period. Optionally, the signatures are assigned with at least one performance metric generated by the machine learning model.

Method block 506 continues method 500 with receiving network data about a telecommunications network. In one example, the network data comprises at least two of mean opinion score, jitter, latency, packet loss, throughput, processor utilization, memory usage, retransmission rate, and hard disk performance. In a further example the network data is about a 5G telecommunications network.

Method block 508 continues with generating the plurality of performance metrics from the network data.

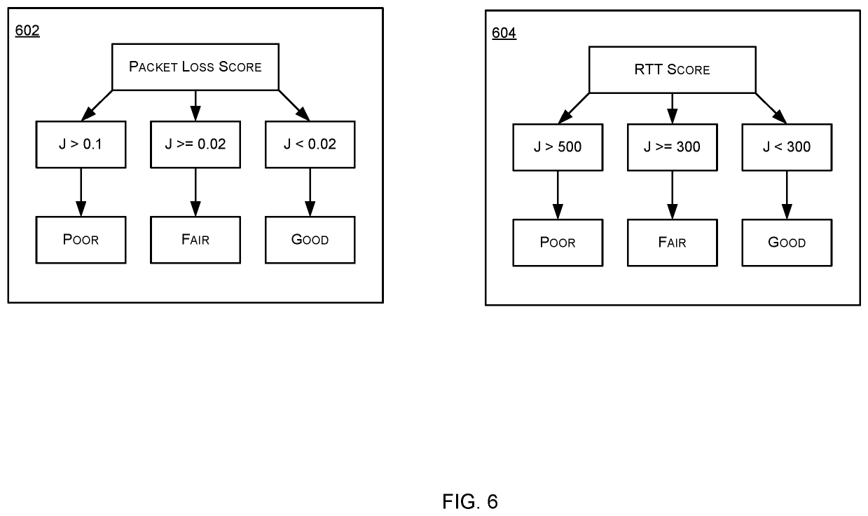

In method block 510 method 500 continues with ranking the signatures according to a prioritization scheme to obtain a highest-priority signature 118. In one example the prioritization scheme is learned using a reinforcement learning model. Alternatively, the prioritization scheme is a logical ranking. With logical ranking, a generalized score is applied to each performance metric in each signature by applying a predefined threshold to each performance metric. This process is shown in FIG. 6 where two different performance metrics, Packet Loss Score 602 and Round-Trip Time Score 604 are generalized to a score of poor, fair and good. With these generalized scores the overall impact of the performance metrics 120 can be appreciated even though they are measured differently. The signatures are then ranked based on the number of performance metrics 120, the impact score of the performance metrics 120, and any historical preferences.

In method block 512 the method 500 continues with presenting the highest-priority signature 118 to an operator. Where the highest-priority signature comprises instructions to perform an action on the network to alleviate the network problem, this is also presented to the operator. In an example a dashboard is generated to present the signature. The dashboard includes the performance metrics 120 and a label for the associated network problem. Additionally, the dashboard includes generated graphs from the performance metrics 120. Additionally, or alternatively, presenting the highest-priority signature 118 includes forwarding the highest-priority signature to a generative AI model, receiving a suggestion from the generative AI model about the network problem, and presenting the suggestion to the operator.

Method 500 continues in method block 514 with receiving feedback from the operator about the highest-priority signature 118. Where a dashboard is presented to the operator, a feedback portion of the dashboard is included and receives the feedback as input from the operator. The feedback is about quality of the information in the signature, applicability of the highest-priority signature to the network problem, the impact of the network problem, next steps taken to resolve the network problem or any other information that can be used to improve the priority ranking. While feedback is taken directly from the operator additionally in some examples the feedback is taken autonomously and is based at least on the actions of the operator after the presentation of the highest-priority signature 118. Optionally, positive feedback on the highest-priority signature 118 automatically triggers an action on the telecommunications website. Actions include, updating forwarding tables, updating firewall lists, instantiating new network functions, restarting an application, traffic shaping actions, proactive notification to customers of work ongoing or problems being addressed etc.

Method block 516 finishes the method 500 by updating the prioritization scheme using the feedback. When a reinforcement learning model is used the prioritization model is updated by adjusting the reward function based on the feedback. For example, where positive feedback is received for a signature, the reward function is adjusted such that a higher reward is provided for selecting the same signature in the future for a similar environment (plurality of signatures and their performance metrics 120). Alternatively, for negative feedback the reward function is adjusted in the opposite manner. Where the prioritization scheme uses logical ranking, the thresholds for performance metrics 120 are adjusted to emphasize signatures which receive positive feedback. |In one example the method 500 is extended to trigger a management action on a 5G telecommunications network in dependence on the highest-priority signature.

Method 500 is performed by one or more processors carrying out instructions stored in a memory. In one example the method blocks are carried out across a global control plane and a site control plane.

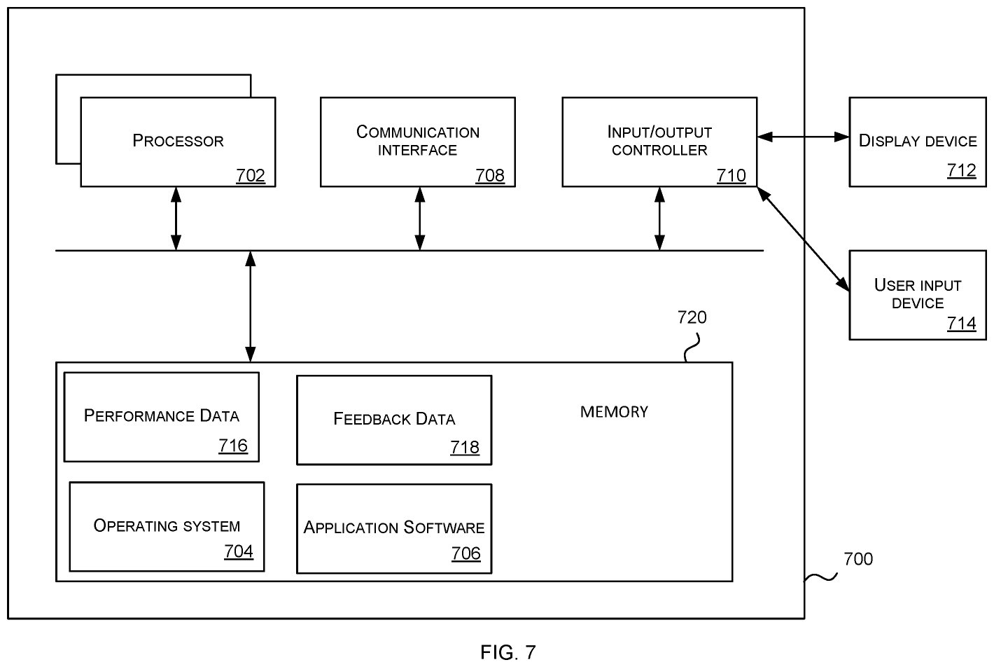

FIG. 7 illustrates various components of an exemplary computing-based device 700 which are implemented as any form of a computing and/or electronic device, and in which embodiments of FIGS. 1-6 are implemented in some examples.

Computing-based device 700 comprises one or more processors 702 which are microprocessors, controllers, or any other suitable type of processors for processing computer executable instructions to control the operation of the device to generate, present and update signatures of network problems for a telecommunications network.

In some examples, for example where a system on a chip architecture is used, the processors 702 include one or more fixed function blocks (also referred to as accelerators) which implement a part of the method of 500 in hardware (rather than software or firmware). Platform software comprising an operating system 704 or any other suitable platform software is provided at the computing-based device to enable application software 706 to be executed on the device.

The computer executable instructions are provided using any computer-readable media that is accessible by computing based device xxx. Computer-readable media includes, for example, computer storage media such as memory 720 and communications media. Computer storage media, such as memory 720, includes volatile and non-volatile, removable, and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 720) is shown within the computing-based device 700 it will be appreciated that the storage is, in some examples, distributed or located remotely and accessed via a network or other communication link (e.g., using communication interface 708).

The computing-based device 700 also comprises an input/output controller 710 arranged to output display information to a display device 712 which may be separate from or integral to the computing-based device 700. The display information may provide a graphical operator interface. The input/output controller 710 is also arranged to receive and process input from one or more devices, such as an operator input device 714 (e.g., a mouse, keyboard, camera, microphone or other sensor). In some examples the operator input device 714 detects voice input, operator gestures or other operator actions and provides a natural operator interface (NUI). This operator input may be used to provide feedback on the highest-priority signature 118, perform actions on the telecommunications network and to create a signature by specifying the network problem and two or more performance metrics 120. In an embodiment the display device 712 also acts as the operator input device 714 if it is a touch sensitive display device. The input/output controller 710 outputs data to devices other than the display device in some examples, e.g., a locally connected printing device (not shown in FIG. 7).

Any of the input/output controller 710, display device 712 and the operator input device 714 may comprise NUI technology which enables an operator to interact with the computing-based device in a natural manner, free from artificial constraints imposed by input devices such as mice, keyboards, remote controls, and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (RGB) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

Clause A. A computer-implemented method comprising:
generating a plurality of signatures, each signature being associated with a different network problem;
assigning to each signature a plurality of performance metrics 120 that indicate the network problem associated with the respective signature, wherein, for each signature, the performance metrics are generated by two or more different types of models; receiving network data about a telecommunications network;
generating the plurality of performance metrics from the network data;
ranking the signatures according to a prioritization scheme to obtain a highest-priority signature;
presenting the highest-priority signature to an operator;
receiving feedback from the operator about the highest-priority signature 118;
updating the prioritization scheme using the feedback.

Clause B The method according to clause A wherein each signature further comprises instructions to perform an action on the network to alleviate the associated network problem.

Clause C The method according to clause B wherein presenting the highest-priority signature to the operator further comprises presenting the instructions to perform the action on the network.

Clause D The method according to any preceding clause wherein the network data comprises at least two of: mean opinion score, jitter, latency, packet loss, throughput, processor utilisation, memory usage, retransmission rate, hard disk performance.

Clause E The method according to any preceding clause wherein the assigning to each signature a plurality of performance metrics further comprises the operator selecting a network problem to associated with the signature and two or more performance metrics from two or more different types of models.

Clause F The method according to any preceding clause wherein the two or more different types of models comprise a rule-based model, a statistical model, and a machine learning model.

Clause G The method according to clause F wherein the rule-based model applies one or more thresholds to one or more respective portions of the network data and records whether these thresholds are exceeded for a specified period.

Clause H The method according to clause F or clause G wherein each signature is assigned at least one performance metric generated using the machine learning model.

Clause I The method according to any preceding clause wherein the prioritization scheme is a reinforcement learning model.

Clause J The method according to clause I wherein the feedback from the operator is used to update a reward function for the reinforcement learning model.

Clause K The method according to any preceding clause further comprising:
assigning a generalised score to each performance metric in each signature by applying a predefined threshold to each performance metric;
wherein the prioritization scheme is a logical ranking based at least on the comparison between the combined scores of the two or more performance metrics in each signature.

Clause L The method according to any preceding clause wherein presenting the highest-priority signature to the operator further comprises, generating a dashboard comprising the performance metrics and associated network problem from the highest-priority signature.

Clause M The method according to clause L wherein generating the dashboard further comprises, generating graphs for the assigned performance metrics of the highest-priority signature.

Clause N The method according to clause L or clause M wherein the dashboard includes a feedback portion that takes input from the operator as feedback on the highest-priority signature.

Clause O The method according to any preceding clause wherein the feedback includes one or more of: feedback about quality of information, applicability of the signature to the network problem, impact the network problem caused and next steps taken to resolve the network problem.

Clause P The method according to any preceding clause wherein at least a portion of the feedback is collected autonomously from the operator based at least on the actions of the operator following the presenting of the highest-priority signature to the operator.

Clause Q The method according to any preceding clause further comprising in response to the feedback being positive, automatically triggering an action on the telecommunications network.

Clause R The method according to any preceding clause wherein presenting the highest-priority signature to the operator further comprises forwarding the highest-priority signature to a generative artificial intelligence (AI) model, receiving a suggestion from the generative AI model about the network problem, and including the suggestion in the presentation.

Clause S An apparatus comprising:
a processor;
a memory storing instructions which when executed by the processor implement a method comprising:
   generating a plurality of signatures, each signature being associated with a different network problem;
assigning to each signature a plurality of performance metrics that indicate the network problem associated with the respective signature, wherein, for each signature the performance metrics are generated by two or more different types of models; receiving network data about a telecommunications network;
generating the plurality of performance metrics from the network data;
ranking the signatures according to a prioritization scheme to obtain a highest-priority signature;
presenting the highest-priority signature to an operator;
receiving feedback from the operator about the highest-priority signature;
updating the prioritization scheme using the feedback.

Clause T A computer-implemented method comprising:
generating a plurality of signatures, each signature being associated with a different network problem of a 5G telecommunications network;
assigning to each signature a plurality of performance metrics that indicate the network problem associated with the respective signature, wherein, for each signature, the performance metrics are generated by two or more different types of models; receiving network data about the 5G telecommunications network;
generating the plurality of performance metrics from the network data;
ranking the signatures according to a prioritization scheme to obtain a highest-priority signature;
presenting the highest-ranking signature to a user;
receiving feedback from the user about the highest-priority signature;
updating the prioritization scheme using the feedback and triggering a management action on the 5G telecommunications network in dependence on the highest-priority signature.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g., in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer can store an example of the process described as software. A local or terminal computer is able to access the remote computer and download a part or all of the software to run the program. Alternatively, the local computer may download pieces of the software as needed or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all the stated problems or those that have any or all the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A computer-implemented method comprising:
generating a plurality of signatures, each signature being associated with a different network problem;
assigning to each signature a plurality of performance metrics that indicate the network problem associated with the respective signature, wherein, for each signature, the performance metrics are generated by two or more different types of models;
receiving network data about a telecommunications network;
generating the plurality of performance metrics from the network data;
ranking the signatures according to a prioritization scheme to obtain a highest-priority signature;
presenting the highest-priority signature;
receiving feedback about the highest-priority signature; and
updating the prioritization scheme using the feedback.

2. The method according to claim 1, wherein each signature further comprises instructions to perform an action on the network to alleviate the associated network problem.

3. The method according to claim 2, wherein presenting the highest-priority signature further comprises presenting the instructions to perform the action on the network.

4. The method according to claim 1, wherein the network data comprises at least two of: mean opinion score, jitter, latency, packet loss, throughput, processor utilisation, memory usage, retransmission rate, or hard disk performance.

5. The method according to claim 1, wherein the assigning to each signature a plurality of performance metrics further comprises receiving a selection of a network problem to associate with the signature and two or more performance metrics from two or more different types of models.

6. The method according to claim 1, wherein the two or more different types of models comprise a rule-based model, a statistical model, and a machine learning model.

7. The method according to claim 6, wherein the rule-based model applies one or more thresholds to one or more respective portions of the network data and records whether these thresholds are exceeded for a specified period.

8. The method according to claim 6, wherein each signature is assigned at least one performance metric generated using the machine learning model.

9. The method according to claim 1, wherein the prioritization scheme is a reinforcement learning model.

10. The method according to claim 9, wherein the feedback is used to update a reward function for the reinforcement learning model.

11. The method according to claim 1, further comprising:
assigning a generalised score to each performance metric in each signature by applying a predefined threshold to each performance metric;
wherein the prioritization scheme is a logical ranking based at least on a comparison between combined scores of two or more performance metrics in each signature.

12. The method according to claim 1, wherein presenting the highest-priority signature further comprises generating a dashboard comprising the performance metrics and associated network problem from the highest-priority signature.

13. The method according to claim 12, wherein generating the dashboard further comprises generating graphs for assigned performance metrics of the highest-priority signature.

14. The method according to claim 12, wherein the dashboard includes a feedback portion that receives input as feedback on the highest-priority signature.

15. The method according to claim 1, wherein the feedback includes one or more of: feedback about quality of information, applicability of the signature to the network problem, impact the network problem caused, or next steps taken to resolve the network problem.

16. The method according to claim 1, wherein at least a portion of the feedback is collected autonomously based at least on actions of an operator following the presenting of the highest-priority signature.

17. The method according to claim 1, further comprising in response to the feedback being positive, automatically triggering an action on the telecommunications network.

18. The method according to claim 1, wherein presenting the highest-priority signature further comprises forwarding the highest-priority signature to a generative artificial intelligence (AI) model, receiving a suggestion from the generative AI model about the network problem, and including the suggestion in the presentation.

19. An apparatus comprising:
a processor;
a memory storing instructions which, when executed by the processor, cause the apparatus to perform operations comprising:
generating a plurality of signatures, each signature being associated with a different network problem;
assigning to each signature a plurality of performance metrics that indicate the network problem associated with the respective signature, wherein, for each signature the performance metrics are generated by two or more different types of models;
receiving network data about a telecommunications network;
generating the plurality of performance metrics from the network data;
ranking the signatures according to a prioritization scheme to obtain a highest-priority signature;
presenting the highest-priority signature;
receiving feedback about the highest-priority signature; and
updating the prioritization scheme using the feedback.

20. A computer-implemented method comprising:
generating a plurality of signatures, each signature being associated with a different network problem of a 5G telecommunications network;
assigning to each signature a plurality of performance metrics that indicate the network problem associated with the respective signature, wherein, for each signature, the performance metrics are generated by two or more different types of models;
receiving network data about the 5G telecommunications network;
generating the plurality of performance metrics from the network data;
ranking the signatures according to a prioritization scheme to obtain a highest-priority signature;
presenting the highest-priority signature;
receiving feedback about the highest-priority signature;
updating the prioritization scheme using the feedback; and
triggering a management action on the 5G telecommunications network in dependence on the highest-priority signature.
